(19) United States
(12) Patent Application Publication
(10) Pub. No.: US 2010/0045707 A1
(43) Pub. Date: Feb. 25, 2010

(54) COLOR SEQUENTIAL METHOD FOR DISPLAYING IMAGES

(75) Inventors: Yi-Pai Huang, Chiayi City (TW); Fang-Cheng Lin, Taichung County (TW); Ching-Ming Wei, Taichung City (TW); Wuan-Zheng Yi, Taichung City (TW); Sheng-Chang Chen, Taoyuan County (TW); Chi-Neng Mo, Taoyuan County (TW); Han-Ping D. Shieh, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/262,193

(22) Filed: Oct. 31, 2008

(30) Foreign Application Priority Data
Aug. 19, 2008 (TW) 97131641

(51) Int. Cl. G09G 5/10

(52) U.S. Cl. 345/690

(57) ABSTRACT

A color sequential method for displaying images is suitable for applying in a display with pixels. Each of frames is formed by displaying a first sub-frame, a second sub-frame and a third sub-frame within a displaying time by the pixels. By calculating differences in gray levels between neighboring pixels, variations are gained. Then, a first just noticeable difference is provided, and the pixels having the variations larger than the first just noticeable difference are detected. Next, times of displaying the first, the second and the third sub-frames in the pixels are raised within the displaying time.

### CROSS-REFERENCE TO RELATED APPLICATION

This application claims the priority benefit of Taiwan application serial no. 97131641, filed on Aug. 19, 2008. The entirety of the above-mentioned patent application is hereby incorporated by reference herein and made a part of specification.

### BACKGROUND OF THE INVENTION

1. Field of the Invention

The present invention relates to a method for displaying images, particularly to an improvement in a color sequential method for displaying images.

2. Description of Related Art

In the art of a color sequential method for displaying images, each frame is formed by three or more sub-frames with a single color. With a sufficient displaying frequency and by sequentially displaying red, green and blue sub-frames, the human eyes are able to perceive a full color image. With the displaying technology of the color sequential method for displaying the images, the volume of a display is reduced, so that a higher spatial resolution is obtained at a low cost.

However, when a static frame is displayed using the color sequential method for displaying the images, the human eyes easily perceive color breakup (CBU) in regions where brightness variations are larger when the human eyes alternatively view different parts of the frame. An object that moves fast in a dynamic frame also causes the human eyes to perceive the CBU in the displayed frame. Said conditions result in an unfavorable visual effect to a user. Completing one sub-frame requires sequential completion of signal writing, liquid crystal reaction and backlight emission. Therefore, if the present problem is resolved by entirely increasing the frame rate of the display, limitation by the reaction speed of the liquid crystal molecules occurs so that resolution is hard to achieve.

### SUMMARY OF THE INVENTION

The present invention provides a color sequential method for displaying images, which increases displaying frequencies in certain parts of a frame, so that a problem of CBU is effectively resolved.

The present invention provides a color sequential method for displaying images, which is suitable for applying in a display having a plurality of pixels. The pixels of the present invention are suitable for sequentially displaying a plurality of frames, wherein the pixels display each of the frames by displaying a first sub-frame, a second sub-frame and a third sub-frame within a displaying time. In addition, differences in gray levels between the neighboring pixels in the same frame are calculated, so that a plurality of variations is respectively gained. Then, a first just noticeable difference (JND) is provided, and the pixels having variations larger than the first JND are detected. Next, in the frames, times of displaying the first, the second and the third sub-frames in the pixels having the variations larger than the first JND are raised within the displaying time.

According to an embodiment of the present invention, the color sequential method for displaying images further comprises comparing two successively displayed frames, and calculating a moving speed of a corresponding image in the two frames. Next, a second JND is provided, and the pixels having the variations larger than the second JND are detected. Thereafter, in the frames, times of displaying the first, the second and the third sub-frames in the pixels having the variations larger than the second JND are raised within the displaying time.

According to an embodiment of the present invention, the displaying time is 1/60 second.

According to an embodiment of the present invention, a method for raising the times of displaying the first, the second and the third sub-frames within the displaying time comprises sequentially displaying the first, the second, the third, the first, the second and the third sub-frames.

According to an embodiment of the present invention, the first, the second and the third sub-frames are respectively red, green and blue frames.

According to an embodiment of the present invention, a method for raising the times of displaying the first, the second and the third sub-frames within the displaying time comprises sequentially displaying the first, the second, the third, the third, the first, the second, the second, the third and the first sub-frames.

According to an embodiment of the present invention, the first, the second and the third sub-frames are respectively red, green and blue frames.

The color sequential method for displaying the images of the present invention increases displaying frequencies in regions in a static frame where brightness variations are relatively large, so that the perception of the CBU is avoided when different parts of the frame are alternatively viewed. In addition, the color sequential method for displaying the images of the present invention increases the displaying frequencies of fast-moving objects in a dynamic frame, so that a problem on the CBU of the moving objects in the frame is effectively avoided. Moreover, the color sequential method for displaying the images of the present invention does not require an increase in signal writing frequencies in all parts of the frame, but selectively increases the signal writing frequencies in parts of the frame to improve the problem of CBU. Therefore, the quality of the displayed frame is effectively improved.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view on a display of the present invention.

FIG. 2 is a schematic view showing a step flowchart of a color sequential method for displaying images of the present invention.

FIGS. 2A to 2C are rating tables of perceived CBU degrees when the CBU is perceived by the human eyes at different viewing distances.

FIG. 3A is a schematic view of regions of different statuses in a frame of the present invention.

FIG. 3B is a schematic view showing times of displaying sub-frames of the present invention.

FIG. 4A is a schematic view of different statuses of regions in a frame of the present invention.

FIG. 4B is a schematic view showing times of displaying sub-frames of the present invention.

FIG. 4C is a schematic view illustrating another distribution status of regions in a frame of the present invention.

### DESCRIPTION OF EMBODIMENTS

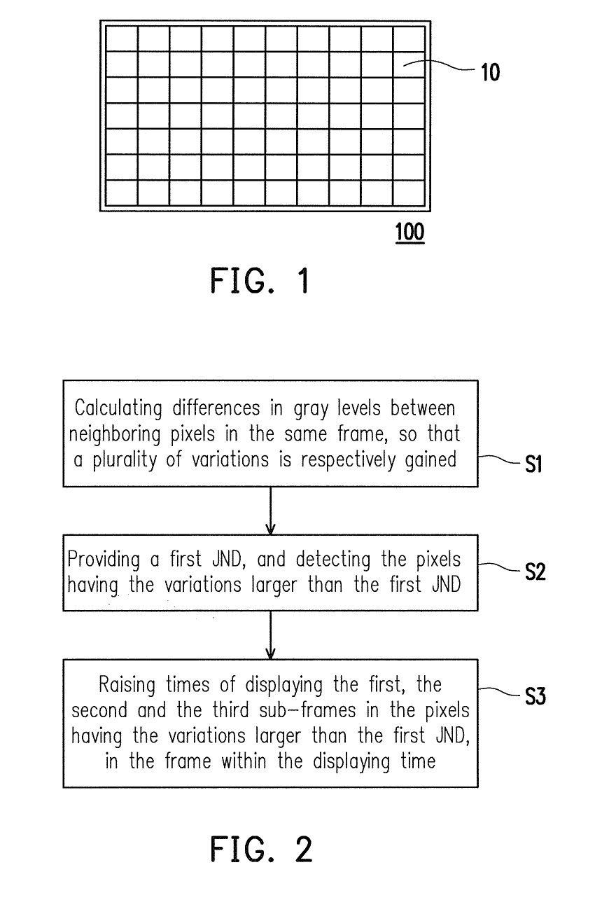

FIG. 1 is a schematic view on a display of the present invention. Referring to FIG. 1, a display 100 has a plurality of pixels 10. A color sequential method for displaying images of the present invention is suitable for making the display 100 display a plurality of frames through the pixels 10 sequentially. Each of the frames displayed on the pixels 10 is formed by displaying a first sub-frame, a second sub-frame and a third sub-frame within a displaying time. According to an embodiment, the first, the second and the third sub-frames are red, green and blue frames respectively.

For example, the displaying time for each of the frames is 1/60 second. This means that in 1 second, the display 100 displays 60 frames, so that the human eyes are able to perceive a continuous image though visual retention. In addition, in 1/60 second, each of the frames becomes a full color frame by quickly displaying red, green and blue frames. Therefore, the human eyes continuously perceive a full color image.

However, when a position gazed by the human eyes is changed between two regions with larger brightness variations in a static frame, CBU in the frame is easily perceived. When the human eyes stare on a fast-moving object in a dynamic frame, the CBU in the frame is also easily perceived. This can be explained by the following equation.

D=0.779*L_{T}^{0.01}*V^{0.89}

Here, D is a threshold distance for not discerning the CBU, L_{T} is a brightness of an image of an object, and V is a relative moving speed between the human eyes and the image of the object. During the brighter image on the object period or the faster relative moving speed between the image on the object and the human eyes period, a user must keep a farther distance from the display 100 to avoid visually perceiving the CBU of the image on the object. In reality, the user maintains a fixed distance when viewing an image displayed by the display 100. Therefore, the human eyes very likely perceive CBU caused by the brightness and the relative moving speed of the image on the object.

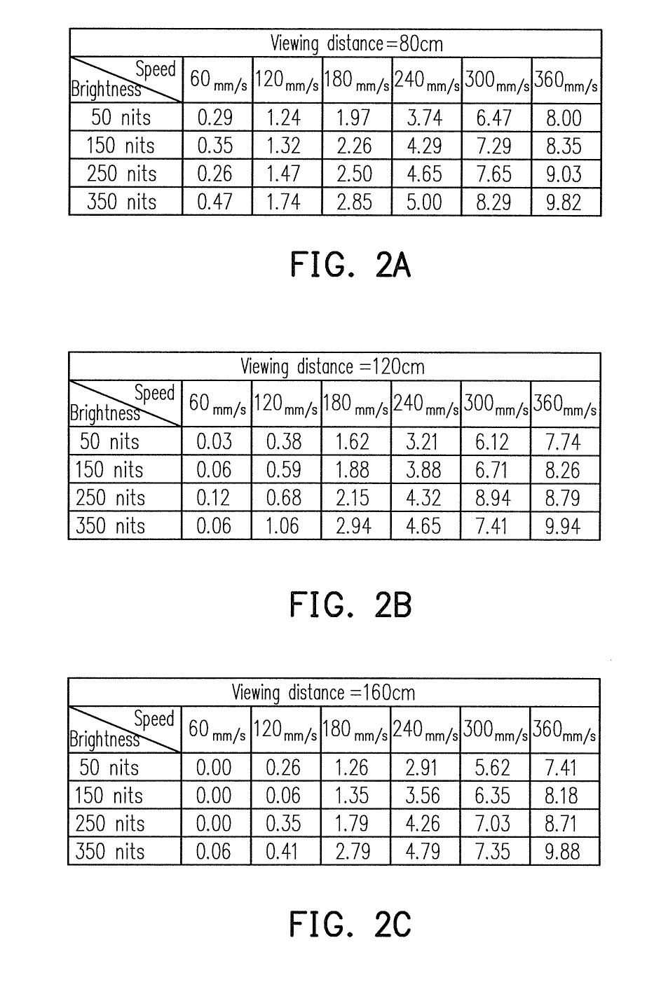

In order to improve a CBU problem in the static frame, the color sequential method for displaying the images of the present invention sequentially performs steps S1 to S3 as in FIG. 2. Referring to step S1, the differences in gray levels between neighboring pixels 10 in the same frame are calculated, so that a plurality of variations ΔB is respectively gained. Then referring to step S2, a first JND J1 is provided, and the pixels 10 having variations ΔB larger than the first JND J1 are detected. This means that the pixels 10 are especially dark or bright, so that the human eyes easily perceive CBU. In practice, regions on the especially dark or bright pixels 10 are likely movie subtitles; for example a white subtitle on a black background or a black subtitle on a white background. Next, referring to step S3, times of displaying the first, the second and the third sub-frames in the pixels 10 having variations larger than the first JND J1 are raised in the frames within the displaying time. This means that the frame rates in some regions are increased.

It should be noted that a configuration of the first JND J1 is appropriately adjusted according to different situations; this is explained as follows. FIGS. 2A to 2C are rating tables of perceived CBU degrees when the CBU is perceived by the human eyes at different viewing distances. The ratings range from 0 to 10 points. Wherein 0 point means that the human eyes does not perceive CBU, while 10 points means that the human eyes perceives strongest CBU. In FIG. 2A, the viewing distance for a user is 1 time a diagonal distance of a display screen. For example, a size of the display is 32 inches, and the diagonal distance of the display screen is 80 centimeters. Referring to FIG. 2B, the viewing distance for a user is 1.5 times the diagonal distance of the display screen (120 centimeters). Referring to FIG. 2C, the viewing distance for a user is 2 times the diagonal distance of the display screen (160 centimeters).

Referring to FIG. 2A, when an object moves at a speed of 300 mm/s and has a brightness of 50 nits, a CBU rating by the human eyes is 6.47 points. When the object moves at an increased speed of 360 mm/s and has the brightness of 50 nits, the CBU rating by the human eyes is 8 points. This means that as the object moves at a faster speed, the human eyes have a stronger tendency of perceiving CBU.

Referring to FIG. 2B, when the object moves at the speed of 300 mm/s or 360 mm/s and has the brightness of 50 nits, the CBU rating by the human eyes are respectively 6.12 and 7.74 points. The 6.12 points and 7.74 points shown in Table 2B are all lower than the corresponding values of the corresponding situations in Table 2A (6.47 points and 8 points). This means that in the same situation, the farther the viewing distance is, the less obvious the CBU the human eyes perceive.

Referring to FIG. 2C, when the object moves at the speed of 300 mm/s and has the brightness of 50 nits, the CBU rating by the human eyes is 5.62 points. Suppose that a viewing distance for a user is 160 centimeters, which is the most common situation. It is configured that if the CBU rating by the human eyes exceeds 5 points, the human eyes do not accept the quality of the display frame. In the present situation, a first JND J1 is configured as 50 nits. Of course, as the brightness and the moving speed of the object changes, the first JND J1 also changes. In addition, a serious standard may be used in the CBU rating by the human eyes. For example, the first JND J1 is configured to above 3 points. The above situation are only used for explanation and not intended for limitation.

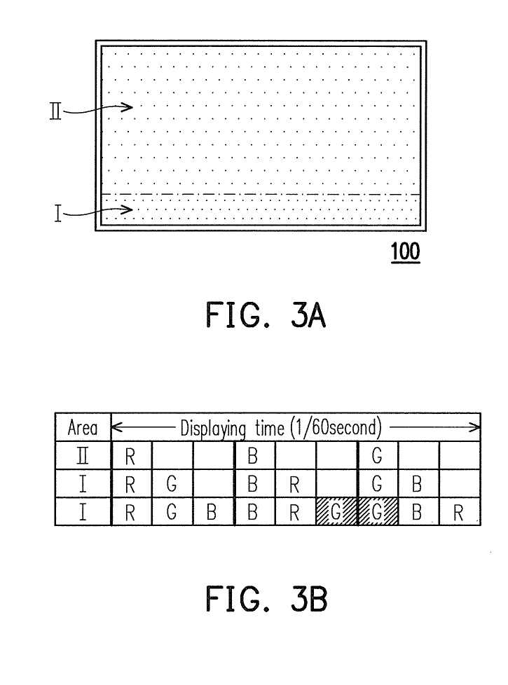

For example, referring to FIG. 3A, a region I in a frame is a subtitle area, and a region II is an image area. FIG. 3B shows times of displaying sub-frames in the region I and the region II within a displaying time. Referring to FIG. 3B, within a displaying time of 1/60 second, the region II only displays 3 sub-frames, which are sequentially a red frame R, a blue frame B and a green frame G. It is noted that, within the displaying time of 1/60 second, the region I displays 6 sub-frames, which are sequentially a red frame R, a green frame G, a blue frame B, a red frame R, a green frame G and a blue frame B. In other words, a frame rate of the region I is increased. Therefore, when the human eyes alternatively view a subtitle area and an image area, a perception of CBU in the subtitle area is avoided.

Of course, within the displaying time of 1/60 second, the region I may also display 9 sub-frames, which are sequentially a red frame R, a green frame G, a blue frame B, a blue frame B, a red frame R, a green frame G, a green frame G, a blue frame B and a red frame R.

In order to eliminate the CBU problem in a dynamic frame, the color sequential method for displaying the images of the present invention compares two successively displayed frames, and calculates a moving speed of a corresponding image in the two frames. Then, a second JND J2 is provided, and the pixels 10 having the variations larger than the second JND J2 are detected. The second JND J2 is configured in similar way as the first JND J1, so that a relevant description is not repeated here. Next, times of displaying the first, the second and the third sub-frames in the pixels 10 having the variations larger than the second JND J2 are raised in the frames within the displaying time. In other words, the color sequential method for displaying the images of the present invention increases the frame rate of images having faster moving speeds.

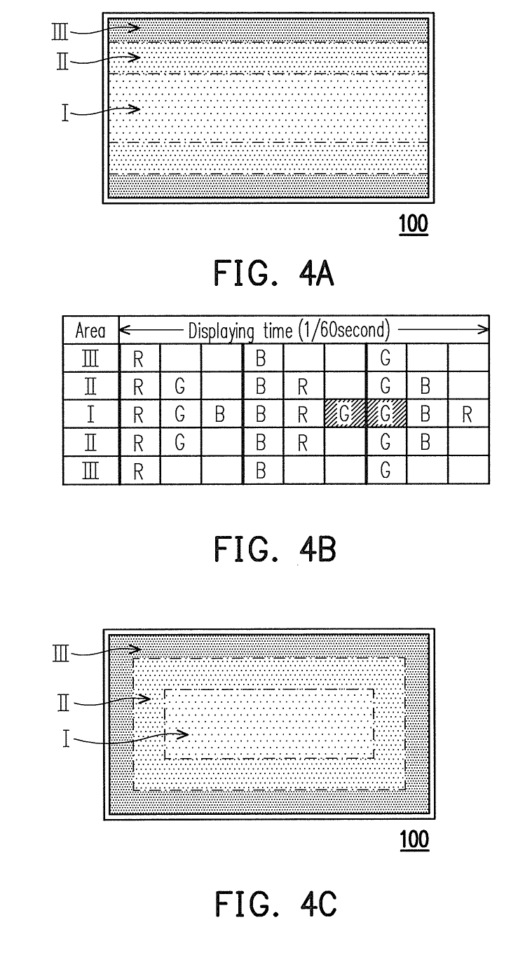

For example, referring to FIG. 4A, an image moving speed in a region I is faster than an image moving speed in a region II, and the image moving speed in the region II is faster than an image moving speed in a region III. Referring to FIG. 4B, the color sequential method for displaying the images of the present invention utilizes a plurality of different frame rates, according to image statuses in the region I, the region II and the region III. Similarly, the region I displays 9 sub-frames, which are sequentially a red frame R, a green frame G, a blue frame B, a blue frame B, a red frame R, a green frame G, a green frame G, a blue frame B and a red frame R. Using the above method, the color sequential method for displaying the images of the present invention effectively resolves a CBU problem in a dynamic frame. Of course, regions may also be arranged as in FIG. 4C. The color sequential method for displaying the images of the present invention utilizes a plurality of different frame rates, according to the image statuses in the region I, the region II and the region III. The above situations are only used for exemplification and not intended for limitation. In practice, the color sequential method for displaying the images of the present invention utilizes a buffer processor (not shown) to pre-process image data, so that the display 100 has a good image quality during displaying an image period.

In summary, the color sequential method for displaying the images of the present invention increases displaying frequencies in certain regions in a static frame where brightness variations are larger, so that the human eyes perceiving CBU when gazing different parts of the frame is avoided. In addition, the color sequential method for displaying the images of the present invention increases displaying frequencies of faster moving objects in a dynamic frame, so that when the CBU is perceived by the human eyes, a problem of CBU of the moving object in the frame is effectively avoided. Therefore, the color sequential method for displaying the images of the present invention adjusts displaying frequencies according to statuses of different regions in a frame to significantly improve quality of the displayed frame.

Although the present invention has been described with reference to the above embodiments, application of the present invention is not limited to these embodiments. It will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A color sequential method for displaying images, suitable for applying in a display having a plurality of pixels, the color sequential method for displaying the images comprising:
sequentially displaying a plurality of frames by the pixels, wherein each of the frames displayed by the pixels is formed by displaying a first sub-frame, a second sub-frame and a third sub-frame within a displaying time;
calculating differences in gray levels between the neighboring pixels in each of the frames, so that a plurality of variations are respectively obtained;
providing a first just noticeable difference, and detecting the pixels having the variations larger than the first just noticeable difference; and
raising times of displaying the first, the second and the third sub-frames in the pixels having the variations larger than the first just noticeable difference in the frames within the displaying time.

2. The color sequential method for displaying the images according to claim 1, further comprising:
comparing two successively displayed frames, and calculating a moving speed of a corresponding image in the two frames;
providing a second just noticeable difference, and detecting the pixels having the variations larger than the second just noticeable difference; and
raising times of displaying the first, the second and the third sub-frames in the pixels having the variations larger than the second just noticeable difference in the frames within the displaying time.

3. The color sequential method for displaying the images according to claim 1, wherein the displaying time is 1/60 second.

4. The color sequential method for displaying the images according to claim 1, wherein a method for raising the times of displaying the first, the second and the third sub-frames within the displaying time comprises sequentially displaying the first, the second, the third, the first, the second and the third sub-frames.

5. The color sequential method for displaying the images according to claim 4, wherein the first, the second and the third sub-frames are respectively a red frame, a green frame, and a blue frame.

6. The color sequential method for displaying the images according to claim 1, wherein a method for raising the times of displaying the first, the second and the third sub-frames within the displaying time comprises sequentially displaying the first, the second, the third, the third, the first, the second, the second, the third and the first sub-frames.

7. The color sequential method for displaying the images according to claim 6, wherein the first, the second and the third sub-frames are respectively a red frame, a green frame, and a blue frame.
